(19) United States
(12) Patent Application Publication
(10) Pub. No.: US 2009/0092682 A1
(43) Pub. Date: Apr. 9, 2009

(54) FUNGICIDAL COMPOSITION FOR THROUGH PERIDERM BARK APPLICATION TO WOODY PLANTS

(76) Inventor: William STRINGFELLOW, Louisburg, KS (US)

Correspondence Address: Arthur M. Reginelli;Renner, Kenner, Greive, Bobak, Taylor & Weber, First National Tower, Fourth Floor, Akron, OH, 44308-1456, US

(21) Appl. No.: 12/336,747

(22) Filed: Dec. 17, 2008

Related U.S. Application Data
(63) Continuation of application No. 10/560,999, filed on Nov. 15, 2006.
(60) Provisional application No. 60/482,224, filed on Jun. 23, 2003.
(60) Provisional application No. 60/493,622, filed on Aug. 8, 2003.

(51) Int. Cl. A01N 59/26

(52) U.S. Cl. 424/605

(57) ABSTRACT

A fungicidal composition for topical application to woody plant periderm, the composition comprising (a) a systemic fungicide, (b) an organosiloxane surfactant, and (c) water.

This application is a Continuation Application of U.S. Non-Provisional application Ser. No. 10/560,999, filed Nov. 15, 2006 and claims the benefit of International Application No. PCT/US04/19847, filed Jun. 23, 2004, which claims the benefit of U.S. Provisional Application No. 60/493,622, filed Aug. 8, 2003, and U.S. Provisional Application No. 60/482,224, filed Jun. 23, 2003.

### FIELD OF THE INVENTION

This invention relates to fungicidal compositions and methods for using the same to treat plant diseases via application to the periderm of the plant.

### BACKGROUND OF THE INVENTION

Many diseases have had a significant impact on species of woody plants over the years. For example, Dutch elm disease has eliminated many of the elm trees in North America. Similarly, chestnut blight, which is also caused by a fungus, has eliminated many of the larger chestnut trees over the last 100 years. Today, sudden oak death, which is caused by the Phytophthora ramorum fungus, threatens many oak trees. And other diseases such as Phytophthora, Pythium, Verticillium, as well as cankers and other pathogens, attack various important plants species.

The ability to control or eliminate these diseases is therefore ecologically and economically critical. The solution to the problem is two-fold. First, an effective fungicide must be identified. And second, an efficient means to systemically deliver these fungicides must be developed.

Various fungicides that have been employed to treat plants infected with pathogens including various salts of phosphorous acid, propiconazole, thiabendazole, mefenoxam, azoxystrobin, fenarimol, myclobutanil, streptomycin, tridimefon, and fosetyl aluminum tris. These fungicides operate systemically by moving throughout the plant's vascular system to attack and interrupt the pathogen's metabolic life cycle processes.

In order to have a systemic impact on the tree, however, these fungicides must be introduced to the trees' vascular system. This can be accomplished by soaking the soil around the tree or by spraying the leaves, i.e., foliar treatment. These methods, however, are not very efficacious and result in chemical trespass to the surrounding environment. Another approach includes direct injection of the fungicide into the tree. While the later method has proven to be efficacious in delivering the fungicide to the vascular system of the tree, the method has other negative impact. To begin with, the applicator must drill a hole in the trunk of the tree or puncture the bark layer with a needle-type device, and then employ specialized equipment to inject the fungicide. Not only is this costly, time consuming, and labor intensive, but the tree can be damaged by the wounds or drilling holes or the needle puncture in the trunk, and also by the concentrated quantity of fungicide injected into a small localized area. Also, the pressure required to force fungicide into the injection site can cause damage to the trunk as the bark can be lifted away from the sap wood.

There is, therefore, a need to develop a more efficient way to treat trees that are susceptible to or infected with disease, especially those diseases caused by fungus or other pathogens.

### SUMMARY OF THE INVENTION

In general the present invention provides a fungicidal composition for topical application to woody plant periderm, the composition comprising (a) a systemic fungicide, (b) an organosiloxane surfactant, and (c) water.

The present invention also includes a fungicidal composition for topical application to woody plant periderm, the composition comprising (a) a systemic fungicide, (b) an organosiloxane surfactant, (c) water, (d) optionally a solvent, and (e) optionally a surface active agent.

The present invention further provides a fungicidal composition for topical application to woody plant periderm, the composition comprising (A) an aqueous solution comprising (i) at least one part by weight of a phosphite compound, and (ii) from about 0.0001 to about 1.0 parts by weight of an organosiloxane surfactant per part of phosphite compound, and (iii) from about 0.0001 to about 1.0 parts by weight of a glycol or glycol ether per part of phosphite compound, where the aqueous solution comprises from about 1 to about 100% by weight of a phosphite compound.

The present invention still further provides a method for preventing and curing disease cause by fungus or other pathogen, the method comprising applying a fungicidal composition to the bark periderm of woody plants without mechanically penetrating the bark of the plant, said fungicidal composition comprising an aqueous solution comprising (i) at least one part by weight of a phosphite compound, and (ii) from about 0.0001 to about 1.0 parts by weight of an organosiloxane surfactant per part of phosphite compound, and (iii) from about 0.0001 to about 1.0 parts by weight of a glycol or glycol ether per part of phosphite compound, where the aqueous solution comprises from about 1 to about 100% by weight of a phosphite compound.

The composition and methods of this invention have advantageously overcome several of the problems associated with prior art methods of applying fungicides to woody plants. To begin with, the fungicide can be applied directly to the bark or periderm without the need for any invasive drilling or puncturing, the need for specialized equipment, or the need for highly trained applicators. Furthermore, because the fungicide is applied directly to the periderm of woody plants, environmental exposure or trespass can be greatly reduced as to compared to foliar applications.

### DETAILED DESCRIPTION OF ILLUSTRATIVE EMBODIMENTS

The fungicidal compositions of this invention can be applied directly to the periderm of woody plants. The compositions include a systemic fungicide and an organosiloxane surfactant. The compositions can be applied to the periderm of woody plants without the need for mechanically penetrating or violating the periderm of the of the woody plant. The term periderm refers to the outer layer of tissue around the stems and the like of woody plants. As those skilled in the art appreciate, this periderm is a cortical protective layer of many roots and stems that typically include phellem, phellogen, and phelloderm.

Systemic fungicides include those that operate moving throughout the plants vascular system. It is believed that these fungicides attack and interrupt the pathogen's metabolic life cycle processes. Alternatively, it is believed that the fungicides may strengthen the plants immune system and thereby assist the plant in overcoming the pathogen. Numerous systemic fungicides may be employed. Exemplary systemic fungicides include aliphatic nitrogen fungicides, amide fungicides, acylamino acid fungicides, furamide fungicides, phenylsulfamide fungicides, valinamide fungicides, anilide fungicides, benzanilide fungicides, furanilide fungicides, sulfonanilide fungicides, antibiotic fungicides, strobilurin fungicides, aromatic fungicides, benzimidazole fungicides, benzimidazole precursor fungicides, benzothiazole fungicides, bridged diphenyl fungicides, carbamate fungicides, benzimidazolylcarbamate fungicides, carbanilate fungicides, conazole fungicides such as imidazole and triazole conazole fungicides, copper fungicides, dicarboximide fungicides, dinitrophenol fungicides, dithiocarbamate fungicides, cyclic dithiocarbamate fungicides, polymeric dithiocarbamate fungicides, inorganic fungicides, imidazole fungicides, inorganic mercury fungicides, organomercury fungicides, morpholine fungicides, organophosphorus fungicides, organotin fungicides, oxathiin fungicides, oxazole fungicides, polysulfide fungicides, pyridine fungicides, pyrimidine fungicides, pyrrole fungicides, quinoline fungicides, quinone fungicides, quinoxaline fungicides, thiazole fungicides, thiocarbamate fungicides, thiophene fungicides, triazine fungicides, triazole fungicides, urea fungicides, and other unclassified fungicides.

Specific examples of aliphatic nitrogen fungicides include butylamine, cymoxanil, dodicin, dodine, guazatine, and iminoctadine. Amide fungicides include carpropamid, chloraniformethan, cyazofamid, cyflufenamid, diclocymet, ethaboxam, fenoxanil, flumetover, furametpyr, prochloraz, quinazamid, silthiofam, and triforine.

Specific examples of acylamino acid fungicides include benalaxyl, benalaxyl-M, furalaxyl, metalaxyl, metalaxyl-M, and pefurazoate. Benzamide fungicides benzohydroxamic acid, tioxymid, trichlamide, zarilamid, zoxamide. Examples of furamide fungicides include cyclafuramid, furmecyclox.

Specific examples of phenylsulfamide fungicides include dichlofluanid, tolylfluanid. Valinamide fungicides include benthiavalicarb, iprovalicarb. Examples of anilide fungicides include benalaxyl, benalaxyl-M boscalid, carboxin, fenhexamid, metalaxyl, metalaxyl-M, metsulfovax, ofurace, oxadixyl, oxycarboxin, pyracarbolid, thifluzamide, and tiadinil.

Specific examples of benzanilide fungicides include benodanil, flutolanil, mebenil, mepronil, salicylanilide, and tecloftalam. Furanilide fungicides include fenfuram, furalaxyl, furcarbanil, and methfuroxam. Examples of sulfonanalide fungicides include flusulfamide.

Specific examples of antibotic fungicides include aureofungin, blasticidin-S, cycloheximide, griseofulvin, kasugamycin, natamycin, polyoxins, polyoxorim, streptomycin, and validamycin. Strobilurin fungicides include azoxystrobin, dimoxystrobin, fluoxastrobin, kresoxim-methyl, metominostrobin, orysastrobin, picoxystrobin, pyraclostrobin, and trifloxystrobin.

Specific examples of aromatic fungicides include biphenyl, chlorodinitronaphthalene, chloroneb, chlorothalonil, cresol, dicloran, hexachlorobenzene, pentachlorophenol, quintozene, sodium pentachlorophenoxide, and tecnazene. Benzimidazole fungicides include benomyl, carbendazim, chlorfenazole, cypendazole, debacarb, fuberidazole, mecarbinzid, rabenzazole, and thiabendazole. Examples of benzimidazole precursor fungicides include furophanate, thiophanate, and thiophanate-methyl.

Specific examples of benzothiazole fungicides include bentaluron, chlobenthiazone, and TCMTB. Specific examples of bridged diphenyl fungicides include bithionol, dichlorophen, and diphenylamine.

Specific examples of carbamate fungicides include benthiavalicarb, furophanate, iprovalicarb, propamocarb, thiophanate, and thiophanate-methyl. Benzimidazolylcarbamate fungicides include benomyl, carbendazim, cypendazole, debacarb, and mecarbinzid. Examples of carbanilate fungicides include diethofencarb.

Specific examples of conazole imidazole fungicides include climbazole, clotrimazole, imazalil, oxpoconazole, prochloraz, and triflumizole. Specific examples of conazole triazole fungicides include azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, and uniconazole-P.

Copper fungicides include Bordeaux mixture, Burgundy mixture, Chestnut mixture copper acetate copper carbonate, basic copper hydroxide copper naphthenate copper oleate, copper oxychloride, copper sulfate, copper sulfate basic, copper zinc chromate, cufraneb, cuprobam, cuprous oxide, mancopper, and oxine copper.

Examples of dicarboximide fungicides include famoxadone, fluoroimide.

Specific examples of dichlorophenyl dicarboximide fungicides include chlozolinate, dichlozoline, iprodione, isovaledione, myclozolin, procymidone, and vinclozolin.

Specific examples of phthalimide fungicides include captafol, captan, ditalimfos, folpet, and thiochlorfenphim.

Specific examples of dinitrophenol fungicides include binapacryl, dinobuton, dinocap, dinocap-4, dinocap-6, dinocton, dinopenton, dinosulfon, dinoterbon, and DNOC. Examples of dithiocarbamate fungicides include azithiram, carbamorph, cufraneb, cuprobam, disulfiram, ferbam, metam, nabam, tecoram, thiram, and ziram. Specific examples of cyclic dithiocarbamate fungicides include dazomet, etem, and milneb. Polymeric dithiocarbamate fungicides include mancopper, mancozeb, maneb, metiram, polycarbamate, propineb, and zineb.

Specific examples of imidazole fungicides include cyazofamid, fenamidone, fenapani, glyodin, iprodione, isovaledione, pefurazoate, triazoxide. Examples of inorganic fungicides include potassium azide, potassium thiocyanat, sodium azide, and sulfur.

Specific examples of inorganic mercury fungicides include mercuric chloride, mercuric oxide, and mercurous chloride. Examples of organomercury fungicides include (3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulphonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, and tolylmercury acetate.

Specific examples of morpholine fungicides include aldimorph, benzamorf, carbamorph, dimethomorph, dodemorph, fenpropimorph, flumorph, and tridemorph. Examples of organophosphorus fungicides include ampropylfos, ditalimfos, edifenphos, fosetyl, hexylthiofos, iprobenfos, phosdiphen, pyrazophos, tolclofos-methyl, and triamiphos. Specific examples of organotin fungicides include decafentin, fentin, and tributyltin oxide.

Specific examples of oxathiin fungicides include carboxin, and oxycarboxin.

Oxazole fungicides include chlozolinate, dichlozoline, drazoxolon, famoxadone, hymexazol, metazoxolon, myclozolin, oxadixyl, vinclozolin. Examples of polysulfide fungicides include barium polysulfide, calcium polysulfide, potassium polysulfide, and sodium polysulfide.

Specific examples of pyridine fungicides include boscalid, buthiobate, dipyrithione, fluazinam, pyridinitril, pyrifenox, pyroxychlor, and pyroxyfur. Pyrimidine fungicides include bupirimate, cyprodinil, diflumetorim, dimethirimol, ethirimol, fenarimol, ferimzone, mepanipyrim, nuarimol, pyrimethanil, and triarimol. Examples of pyrrole fungicides include fenpiclonil, fludioxonil, and fluoroimide.

Specific examples of quinoline fungicides include ethoxyquin, halacrinate, 8-hydroxyquinoline sulfate, quinacetol, and quinoxyfen. Examples of quinone fungicides include benquinox, chloranil, dichlone, and dithianon. Quinoxaline fungicides include chinomethionat, chlorquinox, and thioquinox.

Specific examples of thiazole fungicides include ethaboxam, etridiazole, metsulfovax, octhilinone, thiabendazole thiadifluor, and thifluzamide. Thiocarbamate fungicides include methasulfocarb and prothiocarb. Examples of thiophene fungicides include ethaboxam, and silthiofam. Specific examples of triazine fungicides include anilazine. Triazole fungicides include bitertanol, fluotrimazole, and triazbutil. Examples of urea fungicides include bentaluron, pencycuron, and quinazamid.

Specific examples of other unclassified fungicides include acibenzolar, acypetacs, allyl alcohol, benzalkonium chloride, benzamacril, bethoxazin, carvone, chloropicrin, DBCP, dehydroacetic acid, diclomezine, diethyl pyrocarbonate, fenaminosulf, fenitropan, fenpropidin, formaldehyde, furfural, hexachlorobutadiene, iodomethane, isoprothiolane, methyl bromide, methyl isothiocyanate, metrafenone, nitrostyrene, nitrothal-isopropyl, OCH, 2-phenylphenol, phthalide, piperalin, probenazole, proquinazid, pyroquilon, sodium orthophenylphenoxide, spiroxamine, sultropen, thicyofen, tricyclazole, and zinc naphthenate.

The preferred systemic fungicide include phosphite compounds, which are salts of phosphorous acid (H₃PO₃). Salts of polyphosphorous acid, hypophosphorous acid, and polyhypophosphorous acid may also be used and, therefore, for purposes of this specification, reference to salts of phosphorous acids or phosphites will include these other compounds.

Suitable phosphorous acid salts include inorganic or mineral salts and organic salts. Useful inorganic salts include alkali or alkaline earth metal salts such as those including lithium, sodium, potassium, rubidium, cesium, beryllium, magnesium, calcium, strontium, and barium salts of phosphoric acid. Heavier metal salts may also be used such as those including copper, iron, nickel, cobalt, manganese, zinc, and aluminum phosphorous acid salts. These phosphorous acid salts are disclosed in U.S. Pat. Nos. 3,968,208, 4,049,801, 4,075,324, 4,139,616, 4,126,678, 4,661,477, 5,514,200, 5,830,255, and 6,113,665 which are incorporated herein by reference. In one or more embodiments, the phosphorous acid salts include monopotassium phosphite (KH₂PO₃), dipotassium phosphite (K₂HPO₃), tripotassium phosphite (K₃PO₃), mixtures of mono and di potassium phosphite, or mixtures of mono, di, and tri potassium phosphite.

Useful organic phosphite salts include nitrogen-containing compounds that can accept a proton from phosphorous acid. These compounds include primary, secondary or tertiary, optionally substituted aliphatic, aromatic, alicyclic or heterocyclic amines or of other nitrogen-containing derivatives, including for example imidazoles, cyclohexylamines, anilines, and morpholines. The aromatic and heterocyclic nitrogen containing compounds may be substituted, preferably with up to three alkyl groups, each containing from 1-4 carbon atoms.

In addition to salts of phosphorous acid, inorganic or organic salts of substituted phosphorous acid compounds such as monoester phosphorous acids can be used. These phosphorous acids and the salts thereof are described in U.S. Pat. No. 5,599,804, which is incorporated herein by reference. Reference within this specification to phosphites or salts of phosphorous acids will include salts of these substituted phosphorous acid compounds.

Useful monoester salts of phosphorous acid include calcium ethyl phosphite, sodium ethyl phosphite, aluminum ethyl phosphite, magnesium isopropyl phosphite, calcium isopropyl phosphite, aluminum isopropyl phosphite, magnesium ethyl phosphite, magnesium isobutyl phosphite, magnesium sec-butyl phosphite, calcium isobutyl phosphite, aluminum N-butyl phosphite, aluminum sec-butyl phosphite, and aluminum isobutyl phosphite.

The phosphite compounds can be prepared by neutralization of or by double replacement reactions of phosphorous acid. For example, in one embodiment, monopotassium phosphite can be prepared by reacting one equivalent of potassium hydroxide with one equivalent of phosphorous acid within an aqueous solution. Or, neutral potassium phosphite (i.e., dipotassium phosphite) can be prepared by reacting two equivalents of potassium hydroxide with one equivalent of phosphorous acid within an aqueous solution. These methods are well known in the art and can be readily undertaken by those skilled in the art.

Aqueous solutions of potassium phosphite are commercially available including those products available under the tradename Agrifos™ (AgriChem; Australia); NutriPhite™, (BiAgro Western; California), Magallen™ (NuFarm); Phos Pro™ (J.H. Bio Tech); Phos Trol™ (NuFarm); Aliette™ (Bayer/Aventis), Phyto Fos™ (Sipcam Agro); Phyto Phos™ (Organic Labs Inc.); Kphite™ (Plant Food Systems); Prophyt™ (Helena Chemical); Ele-Max Phos Phite™ (Helena Chemical); Alliance™ (Cleary Chemical); Phos Guard™ (Cleary Chemical); Vital™ (Griffin Corp.), and Eco Phite™ (Eco Right LLC.).

The organosiloxane surfactant generally includes one or more trisiloxanes such as those described in U.S. Pat. Nos. 3,505,377 and 6,040,272, which are incorporated herein by reference. These trisiloxanes generally include polyoxyalkylene siloxanes, which may be defined by the formula

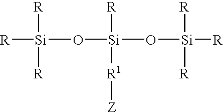

where R is a short chain alkyl group, R¹ is an alkylene group, and Z is a polyoxyalkylene group. The alkyl group may include from 1 to 6 carbon atoms and is preferably methyl. The alkylene group preferably includes from 1 to 10 carbon atoms and is preferably propylene or butylene, and most preferably propylene. The polyoxyethylene preferably includes from 1 to about 30 repeating units based on ethylene or propylene oxide, with ethyleneoxide being preferred. In one embodiment, the polyoxyalkylene group can be defined by the formula —CₙH₂ₙ O(CH₂ CH₂ O)ₐ R², in which n is 3 or 4, a is 1 to about 30, and R² is hydrogen, methyl, ethyl, or an acetyl group. Preferably, blends of two or more alkyl substituted polyalkylene siloxanes are employed in practicing the present invention.

The preferred alkyl substituted polyoxyalkylene siloxanes include polyoxyethylene heptamethyl trisiloxanes. More specifically, the preferred polyoxyethylene heptamethyl trisiloxanes, include those where n is 3 such that a n-propylene or —(CH₂)₃— bridge is present between the middle silicon atom of the trisiloxane group and the polyoxyethylene chain and a is about 5 to about 15. Especially preferred trisiloxanes of this type are commercially available under the tradenames Silwet™ L-77, Silwet™ 408 and Silwet™ 800 (OSI Specialties), Sylgard™ 309 (Dow Corning), Qwikwet™ 100, Qwikwet™ 357, Qwikwet™ 391 (Exacto Inc.), and Kinetic™ (Helena Chemical).

In addition to the fungicide and organosiloxane surfactant, the compositions of this invention may also optionally include a solvent. The compounds that are useful as solvents provide a number of advantageous properties and are therefore generically described in different ways by those skilled in the art. For example, these solvents may also be referred to as coupling agents, emulsifiers, humectants, and pour point depressants.

Useful solvents include alcohols, glycols, glycol esters, and the like. Examples of alcohols include methanol, ethanol, n-propanol, isopropanol, n-butanol, isobutanol, amyl alcohol, methyl amyl alcohol, cyclohexanol, 2-ethylhexanol, furfuryl alcohol, and d-limonene. Examples of glycols and glycol esters include monoethylene glycol, diethylene glycol, propylene glycol or the methyl, ethyl, n-propyl, n-butyl or t-butyl ethers thereof, dipropylene glycol or the methyl, ethyl, n-propyl, n-butyl or t-butyl ethers thereof, tripropylene glycol, or the methyl, ethyl, n-propyl, n-butyl or t-butyl ethers thereof, 1,3-butanediol, 1,4-butanediol, 2-methyl-1,3-propanediol, 2,2-dimethyl-1,3-propanediol, 2-methyl-1,3-pentanediol, 2-methyl-2,4-pentanediol, 2-methyl-1,3-propanediol and 1,4-butanediol. Blends of various solvents may also be used.

In addition to the fungicide and organosiloxane surfactant, and in addition to the solvent, the compositions of this invention may also optionally include a surface active agent. Surface active agents include those compounds defined by ASTM E1519-99, which are materials that when added to a liquid modify the properties of the medium at the surface or interface. These agents are generally known and described in U.S. Patent Application No. 20020107149, which is incorporated herein by reference.

Useful surface active agents include Methylated C6-C19 fatty acids, Methylated Tall oil fatty acids, Methylated Oleic acid, Methylated Linoleic acid, Methylated Linolenic acid, Methylated Stearic acid, Methylated Palmitic acid, Ethylated C6-C19 fatty acids, Ethylated Tall oil fatty acids, Ethylated Oleic acid, Ethylated Linoleic acid, Ethylated Linolenic acid, Ethylated Stearic acid, Ethylated Palmitic acid, Butylated C6-C19 fatty acids, Butylated Tall oil fatty acids, Butylated Oleic acid, Butylated Linoleic acid Butylated Linolenic acid, Butylated Stearic acid, Butylated Palmitic acid, Methylated soybean oil, Ethylated soybean oil, Butylated soybean oil, Methylated canola oil, Ethylated canola oil, Butylated canola oil, Methylated coconut oil, Ethylated coconut oil, Butylated coconut oil, Methylated sunflower oil, Ethylated sunflower oil, Butylated sunflower oil, Paraffinic mineral oils, Naphthenic mineral oils, Aromatic mineral oils, Soybean oil, Canola oil, Cottonseed oil, C6-C19 fatty acids, Tall oil fatty acids, Oleic acid, Linoleic acid, Linolenic acid, Stearic acid, Palmitic acid, Epoxified soybean oil, Alcohol alkoxylate, Alcohol alkoxylate sulfate, Alkylphenol alkoxylate, Alkanolamide, Alkylaryl sulfonate, Amine oxide, Amine, Betaine derivative, Block polymers of ethylene and propylene glycol, Carboxylated alcohol or alkylphenol alkoxylate, Diol, Diphenyl sulfonate derivative, Ether, Ethoxylated amine, Ethoxylated fatty acid, Ethoxylated fatty ester and oils, Ethylene carbonate, Fatty ester, Glycerol ester, Glycol, Phosphate ester surfactant, Propylene Carbonate, Sarcosine derivative, Siloxane-based surfactant, Sorbitan derivative, Sucrose derivative, glucose derivative, Sulfate of alkoxylated alkylphenol, sulfonate of alkoxylated alkylphenol, Sulfate of alcohol, Tristyrylphenol Alkoxylate, A) Alcohol alkoxylates based on branched and linear alcohols containing ethylene oxide or propylene oxide B) Alcohol alkoxylate sulfates, C) Nonylphenol alkoxylate containing ethylene oxide, D) Nonylphenol alkoxylate containing propylene oxide, E) Octylphenols alkoxylate containing ethylene oxide F) Octylphenols alkoxylate containing propylene oxide, G) Fatty amine alkoxylates, H) Butanediols, I) Butyl cellulose ether, J) Butyl carbitol, K) Propylene glycol, L) Ethylene glycol, M) Dipropylene glycol, N) Diethylene glycol, O) Phosphate esters of alcohol alkoxylates, P) Phosphate esters of alkylphenol alkoxylates, Q) Sorbitan esters, R) Alkoxylated sorbitan esters and S) Alkylpolyglucosides. Blends of this foregoing surface active agents may also be employed.

In addition to the fungicide and organosiloxane surfactant, the compositions of this invention may also optionally include a phosphate compound. Useful phosphate compounds include salts of phosphoric acid (i.e., H₃PO₄).

Suitable phosphoric acid salts include inorganic or mineral salts and organic salts. Useful inorganic salts include alkali or alkaline earth metal salts such as those including lithium, sodium, potassium, rubidium, cesium, beryllium, magnesium, calcium, strontium, and barium salts of phosphoric acid. Heavier metal salts may also be used such as those including copper, iron, nickel, cobalt, manganese, zinc, and aluminum phosphorous acid salts. These phosphoric acid salts are disclosed in U.S. Pat. Nos. 5,736,164, 5,800,837, 5,925,383, 5,997,910, 6,338,860, 6,509,041, and 6,139,879, which are incorporated herein by reference. In one or more embodiments, the phosphoric acid salts include monopotassium phosphate (KH2PO4), dipotassium phosphate (K2HPO4), tripotassium phosphate (K3PO4), mixtures of mono and di potassium phosphate, or mixtures of mono, di, and tri potassium phosphate.

In certain embodiments, the pH of the aqueous compositions of this invention is maintained at a pH of about 2 to about 9, more preferably from about 5 to about 7, and even more preferably from about 5.5 to about 6.5. The pH is maintained to prevent the phosphite compounds form being oxidized into phosphate compounds.

The preferred compositions of this invention include at least one part by weight of the systemic fungicide, (e.g., phosphite) and from about 0.0001 to about 3.0 parts by weight of the organosiloxane surfactant. Preferably, the compositions include at least one part by weight of the systemic fungicide and from about 0.001 to about 1.0 parts by weight of the organosiloxane surfactant, more preferably from about 0.003 to about 0.05 parts by weight of the organosiloxane surfactant, still more preferably from about 0.005 to about 0.1 parts by weight of the organosiloxane surfactant per part of systemic fungicide, and even more preferably from about 0.01 to about 0.05 parts by weight of the organosiloxane surfactant per part of systemic fungicide.

When employed, the compositions of this invention include from about 0.0001 to about 1.0, preferably from about 0.001 to about 0.05 parts by weight of the solvent per part of systemic fungicide, more preferably from about 0.005 to about 0.1 parts by weight of the solvent per part of systemic fungicide, and even more preferably from about 0.01 to about 0.05 parts by weight of the solvent per part of systemic fungicide.

When employed, the compositions of this invention include from about 0.0001 to about 2.0, preferably from about 0.001 to about 0.05 parts by weight of the surface active agent per part of systemic fungicide, more preferably from about 0.005 to about 0.1 parts by weight of the surface active agent per part of systemic fungicide, and even more preferably from about 0.01 to about 0.05 parts by weight of the surface active agent per part of systemic fungicide.

When phosphates are employed, the compositions of this invention preferably include from about 0.0001 to about 2.0 parts by weight, more preferably from about 0.001 to about 1.0 parts by weight, even more preferably from about 0.005 to about 0.1 parts by weight, and still more preferably from about 0.01 to about 0.05 parts by weight phosphate per part of fungicide (e.g., phosphite).

The fungicidal compositions of this invention may be applied to the bark or periderm of woody plants by employing a variety of appropriate methods that are well known to those skilled in the art. Typically, the composition is applied to individual trees, woody plants or can applied on a field basis, by employing backpack sprayers, hose end applicators, spot treatment hand spray gun or mechanized spray applicator whether ground or aerially applied. or similar equipment. Advantageously, the composition of this invention can be applied directly to the bark periderm of the tree without mechanically piercing, penetrating, or violating the bark periderm or surface of the tree.

Because the compositions of this invention are aqueous compositions, they can be prepared in a variety of concentrations. Conventionally, concentrated compositions are prepared for purposes of shipping and storage, and then the concentrate is diluted prior to application to the trees. For example, concentrate solutions may be prepared that include from about 1% to about 100% by weight phosphite, more preferably from about 10% to about 50% by weight phosphite, and more preferably from about 20% to about 40% by weight phosphite.

Although not required, the concentrate solution can be diluted at the time of application to any concentration that is believed to provide a desired result. For example, useful compositions may include from about 0.5% to about 100% by weight phosphite, more preferably from about 5% to about 50% by weight phosphite, and even more preferably from about 10% to about 30% by weight phosphite.

The application rate or amount of treatment solution applied to the bark of a tree can vary widely; this is especially true in view of the fact that the concentration of this solution can vary. Moreover, those skilled in the art will be able to readily determine and apply an amount of solution that will be useful for treating any given tree. In general, it is preferred to spray or apply the solution to the bark of a tree until runoff. As those skilled in the art will appreciate, runoff will occur at different loading depending on the texture of the bark. In preferred embodiments, the amount of treatment solution applied to a tree can be calculated based upon the amount that is preferably applied to a standard tree. In other words, for a tree have a DBH (diameter breast height) of about six inches, and where treatment to this tree will include the entire bark surface from the foot or base of the tree up to about six feet, it is preferred to apply from about 25 to about 125 g, more preferably from about 35 to about 105 g, even more preferably from about 45 to about 95 g, and even more preferably form about 50 to about 75 g of the active fungicidal component (e.g., phosphite).

Although the composition of this invention has been described as aqueous solutions, the scope of the invention should not be limited thereto. Accordingly, the term aqueous, as used in the specification is not intended to exclude the presence of a small amount of non-aqueous solvent or dispersions or partial dispersions of the active ingredients disclosed herein.

Without wishing to be bound by any particular theory, it is believed that the surfactant (e.g., alkyl substituted polyoxyalkylene siloxane) and the fungicide (e.g., phosphite compounds) react or interact with one another in such a manner so as to allow the phosphite to penetrate the periderm of woody plants. To the extent that a reaction or interaction occurs, it advantageously occurs without having a deleterious impact on the fungicide's (e.g., phosphite's) ability to treat the targeted disease. In other words, although the surfactant may react or interact with the fungicide to allow it to pass through the periderm, the fungicide continues to be as nearly effective (and in cases improved) in treating disease as if the fungicide were directly injected into the diseased tree.

In order to demonstrate the practice of the present invention, the following examples have been prepared and tested. The examples should not, however, be viewed as limiting the scope of the invention. The claims will serve to define the invention.

### EXAMPLES

### Inoculation

Potted oaks (Quercus agrifolia) in 15 gallon pots were inoculated with Phytopthora ramorum. Specifically, the pathogen was identified by DNA sequencing, isolated, and proliferated in vitro using the common “poison plate” approach (i.e., growth on cooled Agar). The trees were inoculated by using the “under bark” inoculation method whereby a section of the bark is removed and a plug of inoculum is placed on top of the cambium. The bark is then carefully replaced and the inoculation point sealed with cheese cloth and/or grafting wax.

### Example 1

Five inoculated oaks were selected and four were treated with various phosphite solutions by employing varying methods or techniques of application. The characteristics of the solution and the method of application are set forth in Table I along with the results, which are recorded based upon reduction in canker size (based upon diameter measurements). Obviously, the greater the reduction in the canker size, the more effective the treatment in controlling the disease. As used throughout the specification, unless otherwise designated, the percentages are based upon weight percentage.

TABLE I

| | | | Reduction in |
|---|---|---|---|
| Sample | Ingredients | Method | Canker Size |
| 1 | 8% phosphite | injection | ~60% |
| | solution | | |
| 2 | 0.5% phosphite | foliar application | ~40% |
| | solution | | |
| 3 | 0.5% phosphite | soil drench | ~20% |
| | solution | | |
| 4 | 13% phosphite | topical bark | ~0% |
| | solution | | |
| Control | n/a | n/a | 0% |

The methods of application set forth in Table I were as follows. The injection method refers to a method whereby a hole of approximately 3/16″ diameter was drilled near the root flare of each tree. Specifically, 2 to 3 holes were drilled in each tree. A hydraulic applicator was then employed to force about 10 ml of treatment solution into each hole. Foliar application refers to the use of a conventional sprayer to apply the solution until runoff from the foliage is observed. The soil drench method refers to a method whereby the solution was simply poured into the 15 gallon pot in order to fully saturate the soil. In general, about 1 to about 3 gallons of solution was employed. The topical bark application included the use of a hand sprayer to apply about 250 to about 500 ml of solution to the bark of the tree in a location generally from the root flare up to the first or second branch of the tree.

The phosphite solutions employed were those that derive from the reaction of phosphorous acid with potassium hydroxide.

### Example 2

Three inoculated trees were selected and a second set of trials were run using various solutions and techniques in a similar fashion to Example 1. The ingredients of the solution, the method of application, and the results are set forth in Table II.

TABLE II

| | | | Reduction in |
|---|---|---|---|
| Sample | Ingredients | Method | Canker Size |
| Control | 45.8% phosphite | injection | ~80% |
| | solution | | |
| 5 | 75% phosphite - | topical bark | ~80% |
| | 25% surfactant | | |
| 6 | 25% phosphite - | topical bark | ~80% |
| | 75% surfactant | | |

With respect to those solutions that employed the surfactant, the surfactant was obtained under the tradename QUICKWET™ 357, which is believed to include about 90 weight percent organosiloxane surfactant and about 10 percent coupling agent. The phosphite solutions employed in Samples 5 and 6 included about 45.8% phosphite, which was similar to that used in the control, and the percentages set forth in Table II refer to the volume percent of the overall composition when mixed with the surfactant (e.g., 75 volume percent of the 45.8% phosphite solution and 25% volume of the 90% organosiloxane solution).

Notably, as set forth in Example 1, the topical bark application of the phosphite had negligible impact on the treatment of the disease (i.e., the results were similar to the control where no treatment was applied). As also set forth in Example 1, injection of the phosphite solution was rather effective. As set forth in Example 2, where the phosphite solution was used in conjunction with the surfactant, the ability of the phosphite to treat the disease by using a through-bark application was similar to that of injection.

Various modifications and alterations that do not depart from the scope and spirit of this invention will become apparent to those skilled in the art. This invention is not to be duly limited to the illustrative embodiments set forth herein.

What is claimed is:

1. A method for applying a fungicide to a tree, the method comprising:
applying a fungicidal composition to the bark periderm of woody plants without mechanically penetrating or piercing the bark of the plant, the fungicidal composition including (a) a systemic fungicide; (b) an organosiloxane surfactant; and (c) water.

2. The method of claim 1, where said step of applying includes spraying the fungicidal composition on the bark periderm.

3. The method of claim 1, where said step of applying includes an application rate corresponding to applying about 25 to about 125 grams of systemic fungicide to six feet of a tree, measured from the base, where the tree has a diameter breast height of about six inches.

4. The method of claim 1, where said step of applying includes an application rate corresponding to applying about 35 to about 105 grams of systemic fungicide to six feet of a tree, measured from the base, where the tree has a diameter breast height of about six inches.

5. The method of claim 1, where said step of applying includes an application rate corresponding to applying about 45 to about 95 grams of systemic fungicide to six feet of a tree, measured from the base, where the tree has a diameter breast height of about six inches.

6. The method of claim 1, where said step of applying includes an application rate corresponding to applying about 50 to about 75 grams of systemic fungicide to six feet of a tree, measured from the base, where the tree has a diameter breast height of about six inches.

7. The method of claim 1, where the fungicidal composition includes a solvent.

8. The method of claim 7, where the solvent is selected from the group consisting of alcohols, glycols, and glycol esters.

9. The method of claim 7, where the fungicidal composition includes a surface active agent.

10. The method of claim 9, where the surface active agent is selected from the group consisting alcohol alkoxylates based on branched and linear alcohols containing ethylene oxide or propylene oxide, alcohol alkoxylate sulfates, nonylphenol alkoxylate containing ethylene oxide, nonylphenol alkoxylate containing propylene oxide, octylphenols alkoxylate containing ethylene oxide, octylphenols alkoxylate containing propylene oxide, fatty amine alkoxylates, butanediols, butyl cellulose ether, butyl carbitol, propylene glycol, ethylene glycol, mipropylene glycol, diethylene glycol, phosphate esters of alcohol alkoxylates, phosphate esters of alkylphenol alkoxylates, sorbitan esters, alkoxylated sorbitan esters and alkylpolyglucosides.

11. The method of claim 1, where the systemic fungicide is selected from the group consisting of aliphatic nitrogen fungicides, amide fungicides, acylamino acid fungicides, furamide fungicides, phenylsulfamide fungicides, valinamide fungicides, anilide fungicides, benzanilide fungicides, furanilide fungicides, sulfonanilide fungicides, antibiotic fungicides, strobilurin fungicides, aromatic fungicides, benzimidazole fungicides, benzimidazole precursor fungicides, benzothiazole fungicides, bridged diphenyl fungicides, carbamate fungicides, benzimidazolylcarbamate fungicides, carbanilate fungicides, conazole fungicides such as imidazole and triazole conazole fungicides, copper fungicides, dicarboximide fungicides, dinitrophenol fungicides, dithiocarbamate fungicides, cyclic dithiocarbamate fungicides, polymeric dithiocarbamate fungicides, inorganic fungicides, imidazole fungicides, inorganic mercury fungicides, organomercury fungicides, morpholine fungicides, organophosphorus fungicides, organotin fungicides, oxathiin fungicides, oxazole fungicides, polysulfide fungicides, pyridine fungicides, pyrimidine fungicides, pyrrole fungicides, quinoline fungicides, quinone fungicides, quinoxaline fungicides, thiazole fungicides, thiocarbamate fungicides, thiophene fungicides, triazine fungicides, triazole fungicides, and urea fungicides.

12. The method of claim 1, where the systemic fungicide includes a phosphite compound.

13. The method of claim 12, where the phosphite compound is selected from the group consisting of salts of phosphorous acid, salts of polyphosphorous acid, salts of hypophosphorous acid, and salts of polyhypophosphorous acid.

14. The method of claim 13, where the salts of phosphorous acid include monopotassium phosphite, dipotassium phosphite, tripotassium phosphite, mixtures of mono and di potassium phosphite, and mixtures of mono, di, and tri potassium phosphite.

15. The method of claim 12, where the phosphite includes monoester phosphorous acids.

16. The method of claim 1, where the fungicidal composition includes from about 0.0001 to about 3.0 parts by weight of the organosiloxane surfactant per part of systemic fungicide.

17. The method of claim 1, where the fungicidal composition includes from about 0.003 to about 0.05 parts by weight of the organosiloxane surfactant per part of systemic fungicide.

18. The method of claim 7, where the fungicidal composition includes from about 0.0001 to about 1.0 parts by weight solvent per part of systemic fungicide.

19. The method of claim 9, where the fungicidal composition includes from about 0.0001 to about 2.0 parts by weight surface active agent per part of systemic fungicide.

20. The method of claim 12, where the fungicidal composition includes from about 5% to about 50% by weight phosphite.

21. The method of claim 20, where the fungicidal composition includes from about 10% to about 30% by weight phosphite.

22. The method of claim 1, where the organosiloxane surfactant includes a trisiloxane defined by the formula 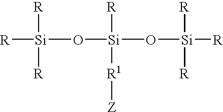
where R is a short chain alkyl group, R¹ is an alkylene group, and Z is a polyoxyalkylene group.

23. The method of claim 22, where the organosiloxane includes a polyoxyethylene heptamethyl trisiloxane.

24. The method of claim 1, where said step of applying a fungicidal composition to the bark periderm of woody plants includes applying the fungicidal composition to the bark of the woody plant in a location from the root flare up to the first branch of the plant.

25. The method of claim 24, where said step of applying a fungicidal composition to the bark periderm of woody plants includes applying the fungicidal composition to the bark of the woody plant in a location from the root flare up to the second branch of the plant.

26. The method of claim 24, where said step of applying includes an application rate corresponding to applying about 25 to about 125 grams of systemic fungicide to six feet of a tree, measured from the base, where the tree has a diameter breast height of about six inches.

27. The method of claim 24, where said step of applying includes an application rate in an amount that the fungicidal composition will runoff the bark.

28. The method of claim 24, where the bark periderm of the woody plant to which the fungicidal composition is applied consists essentially of that portion between the root flare and the first branch.

29. The method of claim 29, where the bark periderm of the woody plant to which the fungicidal composition is applied consists that portion between the root flare and the first branch.
